(19) United States
(12) Patent Application Publication
(10) Pub. No.: US 2014/0192411 A1
(43) Pub. Date: Jul. 10, 2014

(54) Optical Device, Imaging Device And Manufacturing Method Of Imaging Device

(71) Applicant: Kenichiro Hirata, Hachioji-shi (JP)

(72) Inventor: Kenichiro Hirata, Hachioji-shi (JP)

(21) Appl. No.: 14/235,735

(22) PCT Filed: Jul. 27, 2012
(86) PCT No.: PCT/JP2012/069129

§ 371 Date: Jan. 28, 2014

(30) Foreign Application Priority Data
Jul. 28, 2011 (JP) 2011-166107

(51) Int. Cl. G02B 27/00

(52) U.S. Cl. CPC G02B 27/0006
USPC 359/513; 156/109

(57) ABSTRACT

Provided is an optical device and the like which can suppress a decrease in optical performance even under high-temperature heating environments, such as a ref low process. Since at least one of compound lenses 10 and 110 made of heat-resistant resin includes an antireflection structure 51 as a fine asperity structure layer on an inside surface facing a space, even if a subsequent heat treatment is performed, a decrease in optical performance of the lens due to wrinkling can be prevented unlike a case in which an antireflection film is provided. The antireflection structure 51 is covered, for example, by a thin protective layer 52.

### TECHNICAL FIELD

The present invention relates to an optical device such as a lens unit used as an image pickup lens and so on, an imaging device, and a manufacturing method of such an imaging device.

### BACKGROUND ART

Generally, an image pickup lens is provided with antireflection processing to reduce ghost and flare caused by surface reflection. Usual antireflection processing is to provide an optical thin film which is called an antireflection film. Another antireflection processing is to form an antireflection structure which has an antireflection function.

The antireflection structure reduces reflection by forming asperity shapes of the wavelength scale of light or portions with macroscopically small density on a surface of an optical element, such as lens. An antireflection structure is manufactured by, for example, forming a coat on a lens surface and then machining this coat into an antireflection structure (see, for example, PTL 1).

In a microcamera module, a lens unit in which a plurality of lenses are laminated and bonded are used in some cases. In such a lens unit, it is necessary that a space between lenses be a sealed space, because moisture, dust and the like from the outside adhere to an optical path and thereby cause defects. Especially when a lens unit is manufactured using the wafer level optics (WLO) technique, it is important that a space between lenses be a sealed space. Here, the WLO technique is a technique to manufacture a great number of lens units without performing axis adjustment, by forming many lenses on a single wafer, laminating such wafers and then cutting these wafers. In this technique, when the laminated wafers are cut, if the space between the lenses is not a sealed space, debris produced during cutting and water used during cutting enter the space between the lenses and causes defects. Therefore, especially if the WLO technique is used, it is important that the space be a sealed space.

The inventor of this application has found that, if an antireflection film which is an optical thin film is formed on an optical surface facing a sealed space in this kind of lens unit, and if a subsequent heat treatment, such as a ref low process, is performed, modulus of elasticity of resin on the side of the sealed space decreases significantly and the antireflection film becomes wrinkled due to stress of the antireflection film itself, whereby optical performance of the lens unit decreases.

In many cases, an antireflection film usable under high temperature environments is provided with compression stress to prevent cracks. However, under high temperature environments over the glass transition point of resin, such as reflowing, compression stress of the antireflection film exceeds the modulus of elasticity of resin and, therefore, a resin surface is deformed due to compression stress of the antireflection film. The resin surface becomes wrinkled due to deformation at this time (since deformation caused by compression stress increases the surface area of the antireflection film). Therefore, the antireflection film itself also becomes wrinkled. It has been found that, especially in a sealed space, modulus of elasticity of resin on the side of the sealed space decreases significantly during the reflow process, and thus such wrinkles are produced notably. This is considered because, when gas in the sealed space is heated, pressure inside the sealed space is increased and a surface of heated resin is pressurized, whereby resin on the side of the sealed space is more easily subject to elastic deformation. On the other hand, in an antireflection film in which no compression stress exists, cracks easily occur.

Another antireflection processing is to provide an antireflection structure which has an antireflection function. PTL 1 discloses that, after forming a coat on a surface of a lens, this coat is machined into an antireflection structure and that the lens and the antireflection structure are made of different materials.

However, if a base resin material and an antireflection structure or an antireflection film are made of different materials, cracks easily occur due to a difference in modulus of elasticity of the antireflection structure or the antireflection film from that of resin under high temperature environments. For example, if the antireflection structure or the antireflection film is made of an inorganic substance, since the coefficient of linear expansion of inorganic substance is far lower than that of a base resin material, the antireflection structure or the antireflection film is not able to follow expansion of resin and is thus forcibly extended, whereby cracks occur. Further, peeling of the structure or the film at an interface with the base resin easily occurs. As described above, if the lens and the antireflection structure or the antireflection film are made of different materials, cracks and peeling easily occur and thus degradation in optical performance may be caused.

PTL 2 discloses a method for providing an antireflection structure which has an antireflection function directly on a base resin material.

### CITATION LIST

### Patent Literature

[PTL 1] Japanese Unexamined Patent Application Publication No. 2010-48896

[PTL 2] Japanese Unexamined Patent Application Publication (Translation of PCT Application) No. 2010-511079

### SUMMARY OF INVENTION

The present invention is made in view of the above-described related art, an object thereof is to provide an optical device, an imaging device and a manufacturing method of an imaging device which can suppress a decrease in optical performance even under high-temperature heating environments, such as a reflow process.

In order to achieve the above-described object, an optical device according to the present invention includes: a lens; an optical member which faces the lens via a space; and a sealing member which airtightly seals the space disposed between the lens and the optical member, wherein the lens is made of heat-resistant resin and has a fine asperity structure layer on an inside surface facing the space, the asperity structure layer being made of substantially the same material as that of a base of the lens and the asperity structure layer and the base of the lens being formed integrally.

In the optical device of the present invention, the lens made of heat-resistant resin includes the fine asperity structure layer on the inside surface facing the space, and the asperity structure layer is made of substantially the same material as that of a base or substrate of the lens and the asperity structure layer and the base of the lens are formed integrally. Therefore, even if a subsequent heat treatment is performed, a decrease in optical performance of the lens due to, for example, wrinkling, cracks and peeling can be prevented unlike a case in which an antireflection film is provided. This is because, since the asperity structure layer and the base of the lens are made of substantially the same material and thus have substantially equal coefficient of linear expansion, and the asperity structure layer and the base of the lens are formed integrally and thus no stress exists and there is no interface therebetween which causes peeling, it is possible to improve durability to these defects. Here, heat-resistant resin shall mean resin in which degradation in shape of an optical surface or reduction of transmittance after a heat treatment, such as a reflow process, does not easily occur. Further, although some changes may occur in the material composition of the asperity structure layer before or after the formation of the asperity structure layer on the base of the lens depending on the method of formation, such a case in which a material composition of the base of the lens and a material composition of the asperity structure layer are not completely the same are also included in “substantially the same material.”

In a specific aspect or viewpoint of the present invention, the asperity structure layer is an antireflection layer formed by an antireflection structure. In this case, unnecessary reflection on a lens surface can be prevented by the asperity structure layer and thus occurrence of ghost can be prevented.

In another aspect of the present invention, the heat-resistant resin is either of thermosetting resin or photocuring resin. In this case, the resin-made lens can be formed by heat curing or photo-curing, and thus degradation in shape of an optical surface due to deformation of the lens during a subsequent heat treatment, such as a reflow process, can be easily prevented.

In yet another aspect of the present invention, the sealing member is an adhesive which joins the lens and the optical member (for example, a first lens element and a second lens element which will be described later) at a position out of an optical path.

In yet another aspect of the present invention, the sealing member is a lens barrel which mutually aligns and retains the lens and the optical member (for example, the first lens element and the second lens element).

In yet another aspect of the present invention, the sealing member is a spacer which mutually aligns and joins the lens and the optical member (for example, the first lens element and the second lens element).

In yet another aspect of the present invention, the lens includes a flat plate portion; the flat plate portion includes a resin layer which is made of the heat-resistant resin on at least an inside surface facing the space; an outer diameter of the resin layer is smaller than an outer diameter of the flat plate portion; and the spacer is joined to a surface of the flat plate portion at which the flat plate portion is exposed from the resin layer.

In yet another aspect of the present invention, the lens includes an optical surface and a flange surface which extends from the periphery of the optical surface, and the asperity structure layer is provided on the optical surface.

In yet another aspect of the present invention, the lens includes an optical surface and a flange surface which extends from the periphery of the optical surface, and the asperity structure layer is provided on the optical surface and on the flange surface. In this case, since it is not necessary to cover the flange surface with a mask or the like at the time of forming the asperity structure layer on the optical surface, the manufacture procedure can be simplified. If the asperity structure layer is provided on the flange surface, an adhesive may be made to enter the asperity structure to increase an adhesion surface area. Therefore, it is possible to further increase adhesive strength between the lens and the optical member.

In yet another aspect of the present invention, the lens is a first lens element and the optical member is a second lens element. In this case, the optical device functions as a lens unit in which a plurality of lens elements are combined.

In yet another aspect of the present invention, the optical device further includes an imaging element which is disposed at either of a position of the opposite side of the second lens element adjoining the first lens element, or a position of the opposite side of the first lens element adjoining the second lens element, the imaging element being configured to detect a light beam which has passed the first and second lens elements. In this case, the optical device functions as an imaging device in which the lens unit and the imaging element are combined.

In yet another aspect of the present invention, the second lens element includes no fine asperity structure layer made of heat-resistant resin and no antireflection film on a surface facing the space and thus a base or substrate is exposed. In this case, a surface of the first lens element facing the sealed space can be formed by the asperity structure layer and the surface of the second lens element facing the sealed space can be formed by the optical surface which exposes the base or substrate. Therefore, degradation in not only the optical surface of the first lens element but also the optical surface of the second lens element can be suppressed.

In yet another aspect of the present invention, the second lens element is made of heat-resistant resin and has a fine asperity structure layer on a surface facing the space. In this case, the surface of the first lens element facing the sealed space and the surface of the second lens element facing the sealed space can be formed by the antireflection structure or the like which is other than the antireflection film. Therefore, degradation in not only the optical surface of the first lens element but also the optical surface of the second lens element can be suppressed.

In yet another aspect of the present invention, an antireflection film or a protective film is formed on at least one of a surface of the first lens element on the opposite side of the second lens element and a surface of the second lens element on the opposite side of the first lens element. In this case, protection and antireflection of the optical surfaces on the outer side of the first lens element and the second lens element become possible. Since the optical surfaces on the outer side of the first lens element and the second lens element are not on the side of the sealed space during a heat treatment, such as a reflow process, degradation in shape of the optical surface does not easily occur.

In yet another aspect of the present invention, a fine asperity structure layer is formed on at least one of a surface of the first lens element on the opposite side of the second lens element and a surface of the second lens element on the opposite side of the first lens element.

In yet another aspect of the present invention, the optical member is an imaging element configured to detect a light beam which has passed the lens. In this case, the optical device functions as an imaging device in which a lens and an imaging element are combined.

In yet another aspect of the present invention, the asperity structure layer includes an antireflection structure and a protective layer formed on a surface of the antireflection structure. In this case, a fine asperity shape of the antireflection structure can be protected from cracks, dust, soil and the like.

In order to achieve the above-described object, an imaging device according to the present invention includes the optical device described above. The imaging device maintains optical performance thereof at a lens portion even after being subject to a heat treatment, such as a reflow process.

In order to achieve the above-described object, a manufacturing method of an imaging device according to the present invention is a manufacturing method of an imaging device which includes a lens and an optical member which faces the lens via a space, and the method includes: a process to form a fine asperity structure layer which is an antireflection layer made of heat-resistant resin on an inside surface of the lens to face the space; a process to fix the lens and the optical member while airtightly sealing the space disposed between the lens and the optical member by a sealing member; and a process to heat-treat the fixed lens and the optical member.

In the manufacturing method of the imaging device of the present invention, the fine asperity structure layer made of heat-resistant resin is formed on the inside surface of the lens to face the space and, at the same time, the lens and the optical member are fixed to each other while airtightly sealing the space disposed between the lens and the optical member by a sealing member. Therefore, even if a subsequent heat treatment is performed to the lens and the optical member which have been fixed to form a sealed space, a decrease in optical performance of the lens due to wrinkling can be prevented unlike a case in which an antireflection film is provided.

### BRIEF DESCRIPTION OF DRAWINGS

FIG. 1 is a cross-sectional view of a lens unit which is an optical device according to a first embodiment.

FIG. 2 is a diagram illustrating a surface structure of a first compound lens.

FIG. 3 is a diagram illustrating a surface structure of a second compound lens.

FIG. 4 is a diagram illustrating a variation of the surface structure of the second compound lens.

FIG. 5A is a plan view of a first optical element array which is a half-finished product of the lens unit of FIG. 1, and FIG. 5B is a cross-sectional view of the first optical element array taken in the arrow direction of line A-A of FIG. 5A.

FIG. 6 is a cross-sectional view of a second optical element array.

FIG. 7 is a flowchart illustrating a manufacturing process of the first optical element array and the like.

FIGS. 8A, to 8D are diagrams illustrating a molding process of the first optical element array.

FIG. 9 is a schematic diagram illustrating a processing apparatus used to manufacture the first optical element array and the like.

FIG. 10A, is a diagram illustrating a patterning process in the manufacturing process of the first optical element array, FIGS. 10B and 10C are diagrams illustrating an etching process, and FIG. 10D is a diagram illustrating a coating process.

FIG. 11 is a cross-sectional view illustrating a camera module in which the lens unit of FIG. 1 is incorporated.

FIG. 12A is an exterior photograph with an asperity structure layer being manufactured at a sealed space and reflowing having been performed, and FIG. 12B is an exterior photograph with an antireflection film being formed at the sealed space and reflowing having been performed.

FIG. 13A, is a diagram illustrating a camera module of a second embodiment, and FIG. 13B is a diagram illustrating a structure before cutting to form the camera module of FIG. 13A.

FIG. 14 is a cross-sectional view of a camera module of a variation of the second embodiment.

FIG. 15 is a cross-sectional view of a lens unit of a third embodiment.

FIG. 16 is a cross-sectional view of a lens unit of a fourth embodiment.

FIG. 17 is a diagram illustrating an optical element array of a fifth embodiment.

FIG. 18 is a cross-sectional view of a camera module of a sixth embodiment.

### DESCRIPTION OF EMBODIMENTS

### First Embodiment

With reference to the drawings, a structure, a manufacturing method and so forth of a lens unit which is an optical device according to a first embodiment of the present invention will be described.

### A) Structure of Lens Unit

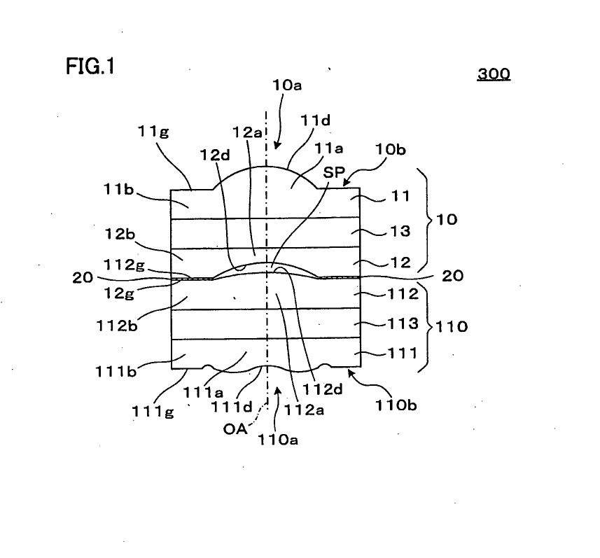

A lens unit 300 illustrated in FIG. 1 is an optical device used, for example, as an image pickup lens. The lens unit (optical device) 300 includes a first compound lens 10 and a second compound lens 110. The first compound lens 10 and the second compound lens 110 are joined and integrated together by an adhesive layer 20 which is a sealing member formed by an adhesive. Thus, a sealed space SP is formed between the first compound lens 10 and the second compound lens 110. Here, the first compound lens 10 can be considered as a first lens element which is one of a plurality of optical elements which constitute the lens unit 300. In this case, the second compound lens 110 is a second lens element which is the another of a plurality of optical elements.

In the lens unit 300 illustrated in FIG. 1, the first compound lens 10 corresponds to a lens and the second compound lens 110 corresponds to an optical member.

The first compound lens 10 is a square pillar-shaped member and has a rectangular outline or contour when seen in a direction of an optical axis OA. The first compound lens 10 includes a main body portion 10a which functions optically, and a flange portion 10b which exists around the main body portion 10a. The first compound lens 10 includes, as a section structure, a first lens layer 11, a second lens layer 12, and a flat plate portion 13 disposed between these lens layers. In the first lens layer 11, a first body layer 11a is provided at a central portion of the compound lens 10 around the optical axis OA and has a circular outline. A first flange layer 11b extends around the first body layer 11a and has a rectangular outline. Also in the second lens layer 12, a second body layer 12a is provided at the central portion of the first compound lens 10 around the optical axis OA and has a circular outline. A second flange layer 12b extends around the second body layer 12a and has a rectangular outline. The first body layer 11a, the second body layer 12a, and an area of the flat plate portion 13 disposed between these body layers 11a and 12a constitute the main body portion 10a on the central side of the first compound lens 10. The first flange layer 11b, the second flange layer 12b, and an area of the flat plate portion 13 disposed between these flange layers 11b and 12b constitute the flange portion 10b on the peripheral side of the first compound lens 10.

The flat plate portion 13 exists because the first compound lens 10 has been cut off from a wafer lens, which will be described later, and divided into a single piece. The flat plate portion 13 is made of, for example, glass, resin, photonic crystal, and these substances with additives added thereto. Glass, transparent resin, and these substances with additives added thereto are especially preferable. The first lens layer 11 is made of heat-resistant resin and is shape-transferred and fixed to one surface of the flat plate portion 13. Materials to be used for the formation of the first lens layer 11 may include photocuring resin, thermosetting resin and an organic-inorganic hybrid material or the like. Specifically, exemplary photocuring resin may include acrylic resin, allyl resin, epoxy-based resin and fluorine-based resin. Exemplary thermosetting resin may include fluorine-based resin and silicone-based resin. An exemplary organic-inorganic hybrid material may include polyimide-titania hybrid. Especially considering heat resistance and workability, UV curable resin and thermosetting resin are desirable as the material to be used for the first lens layer 11. By using resin of which melting point is not lower than 200° C. or resin in which degradation, such as crack, dos not easily occur when heated at not lower than 200° C., degradation in a first optical surface lid, or change in shape, color and the like of an antireflection structure, which will be described later, during a reflow process after molding may be reduced. The reflow process is performed in a range of about 220 to 260° C.; the first lens layer 11 has heat resistance property in terms that optical property thereof is maintained through the reflow process at 260° C. The second lens layer 12 is also made of heat-resistant resin which is the same as that of the first lens layer 11 and is shape-transferred and fixed to the other surface of the flat plate portion 13. Although the first lens layer 11 and the second lens layer 12 may be made of the same material in the range of the materials described above, these lens layers may be made of different materials.

The main body portion 10a at the center of the first compound lens 10 includes the first optical surface 11d on the upper side of the page, i.e., on the outer side, and includes a second optical surface 12d which faces the sealed space SP on the lower side of the page, i.e., the inner side. The flange portion 10b on the peripheral side includes a first flange surface 11g on the outer side and includes a second flange surface 12g which faces a second flange surface 112g of the second compound lens 110, which will be described later, on the inner side.

In the first compound lens 10, a diaphragm may be provided between the flat plate portion 13 and the first lens layer 11 or between the flat plate portion 13 and the second lens layer 12. In this case, an opening of the diaphragm is disposed in alignment with each of the first and second body layers 11a and 12a. An infrared cut off filter may be provided between the flat plate portion 13 and the first lens layer 11 or between the flat plate portion 13 and the second lens layer 12. By providing such an infrared cut off filter film, noise to an imaging element may be reduced and thus performance of a camera module manufactured using the first compound lens 10 and the like may be improved.

The second compound lens 110 is also a square pillar-shaped member and, in the same manner as in the first compound lens 10, includes a main body portion 110a which functions optically, and a flange portion 110b which exists around the main body portion 110a. The second compound lens 110 includes, as a section structure, a first lens layer 111, a second lens layer 112, and a flat plate portion 113 disposed between these lens layers. In the first lens layer 111, a first body layer 111a is provided at a central portion of the compound lens 10 around the optical axis OA and has a circular outline. A first flange layer 111b extends around the first body layer 111a and has a rectangular outline. Also in the second lens layer 112, a second body layer 112a is provided at the central portion of the second compound lens 110 around the optical axis OA and has a circular outline. A second flange layer 112b extends around the second body layer 112a and has a rectangular outline. The first body layer 111a, the second body layer 112a, and an area of the flat plate portion 113 disposed between the body layers 111a and 112a constitute the main body portion 110a on the central side of the second compound lens 110. The first flange layer 111b, the second flange layer 112b, and an area of the flat plate portion 113 disposed between the flange layers 111b and 112b constitute the flange portion 110b on the peripheral side of the second compound lens 110.

The flat plate portion 113 exists because the second compound lens 110 has been cut off from a wafer lens, which will be described later, and divided into a single piece. The flat plate portion 113 is the same as the flat plate portion 13 of the first compound lens 10 and is made of, for example, glass, resin, photonic crystal, and these substances with additives added thereto. The first lens layer 111 is made of heat-resistant resin which is the same as that of the first lens layer 11 of the first compound lens 10 and is shape-transferred and fixed to one surface of the flat plate portion 113. Materials to be used for the formation of the first lens layer 111 may include photocuring resin, thermosetting resin and an organic-inorganic hybrid material or the like as described above. The second lens layer 112 is also made of heat-resistant resin which is the same as that of the first lens layer 111 and is shape-transferred and fixed to the other surface of the flat plate portion 113.

The main body portion 110a at the center of the second compound lens 110 includes a first optical surface 111d on the lower side of the page, i.e., the outer side, and includes a second optical surface 112d which faces the sealed space SP on the upper side of the page, i.e., the inner side. That is, the second optical surface 112d faces the first optical surface 12d of the first compound lens 10 via the sealed space SP. The flange portion 110b on the peripheral side includes a first flange surface 111g on the outer side and includes the second flange surface 112g which faces the second flange surface 12g of the first compound lens 10 on the inner side.

In the second compound lens 110, a diaphragm may be provided between the flat plate portion 113 and the first lens layer 111 or between the flat plate portion 113 and the second lens layer 112. In this case, an opening of the diaphragm is disposed in alignment with each of the first and second body layers 111a and 112a.

The adhesive layer 20 is an adhesive which joins the flange portion 10b of the first compound lens 10 and the flange portion 110b of the second compound lens 110. That is, the adhesive layer 20 functions as a sealing member which airtightly seals the space SP disposed between the first compound lens (first lens element) 10 and the second compound lens (second lens element) 110.

### B) Surface of Lens Element

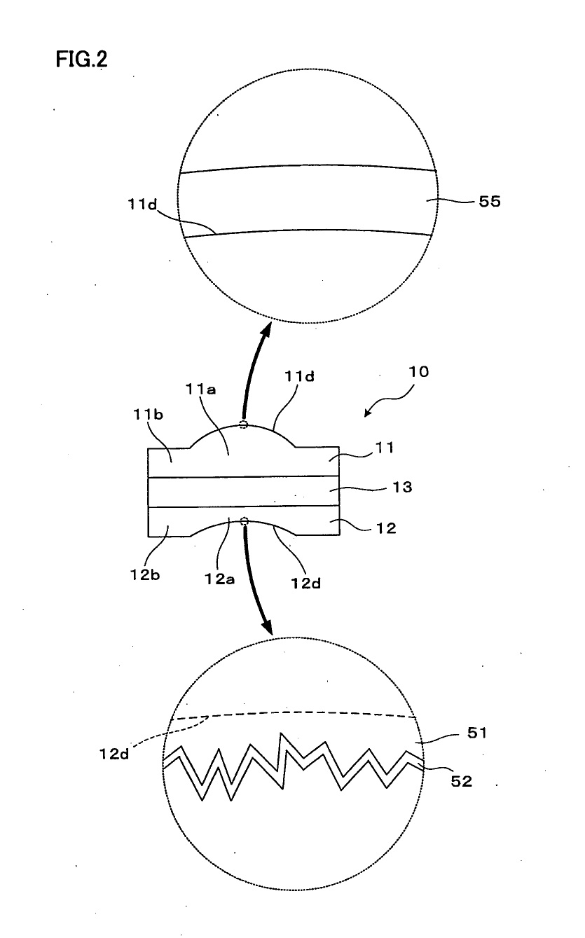

As illustrated in an enlarged view in FIG. 2, in the first compound lens 10, an antireflection film 55 is provided as a coating layer on the first optical surface 11d which is exposed to the outside of the first lens layer 11. The antireflection film 55 is formed by alternately laminating high-refraction materials, such as Ta₂O₅ and TiO₂, and low-refraction materials, such as SiO₂. The antireflection film 55 is formed by, for example, vacuum vapor deposition or sputtering. The antireflection film 55 may be replaced by a protective film made of an inorganic material, such as SiO₂ and Al₂O₃ or the like. Such a protective film is formed by, for example, vapor deposition, sputtering or ion beam sputtering.

On the second optical surface 12d of the second lens layer 12, an antireflection structure 51 and a protective layer 52 are provided as a coating layer or an antireflection layer. In FIG. 2, actually, although no boundary exists between the second optical surface 12d and the antireflection structure 51 clearly, a virtual boundary is illustrated in a dotted line for convenience. The underlying second lens layer 12 is a portion which faces the sealed space SP and the antireflection structure 51 and the protective layer 52 adjoin the sealed space SP.

The antireflection structure 51 is an antireflection layer for reducing reflection on the second optical surface 12d and consists of an asperity structure layer which has a randomly disposed fine asperity shapes within surface of the second optical surface 12d and so forth. The antireflection structure (asperity structure layer) 51 is an antireflection layer which has a tapering structure of which volume density of the asperity shapes increase toward the center or inside of the optical element. That is, the antireflection structure 51 is a collection of substantially cone-shaped fine protrusions and forms a surface. Roughness (Rz: ten point height of asperityities) of the antireflection structure 51 is not less than 10 nm and not greater than 1000 nm. The roughness Rz of the antireflection structure 51 is preferably not less than 50 nm and not greater than 800 nm, and more preferably not less than 250 nm and not greater than 800 nm. The antireflection structure 51 is formed by, for example, using an ion beam. That is, the antireflection structure 51 is formed by etching the second lens layer 12 by the ion beam and, therefore, the antireflection structure 51 is made of substantially the same material as that of a base or substrate of the second lens layer 12 of the first compound lens 10.

Here, generally, reflectance on a certain interface is determined on the basis of a difference between refractive indice of two spaces via the interface. As the difference becomes large, the surface reflection is increased. Since the antireflection structure 51 has an asperity shape formed on the second optical surface 12d and sizes of protrusions are lower than the used wavelength level, no interface having a rapid change in refractive index exists between the antireflection structure 51 and the second optical surface 12d. Therefore, the change in refractive index in the antireflection structure 51 becomes gradual and the rate of surface reflection is decreased. This effect is not dependent on a wavelength or an incidence angle. Therefore, wavelength dependency and angle dependency may be reduced in the antireflection structure 51 as compared with a former type of structure which has a low refractive index layer and a high refractive index layer. The principle of the antireflection of the conventional type of structure which has high and low refractive index layers is on the basis of an interference of light. When light enters vertically to a structure which has a low refractive index layer and the like, the reflectance is reduced most at the wavelength which is four times the film thickness; with respect to the light having an incidence angle θ, an apparent film thickness becomes a product of a substantial film thickness and cos θ. Therefore, in a case of a structure which has a low refractive index layer and the like, unlike the case of the present embodiment, wavelength dependency and incidence angle dependency appear.

The entire surface of the second lens layer 12 is coated with the protective layer 52. The protective layer 52 is formed also on the antireflection structure 51. The protective layer 52 is formed by using, for example, application, vapor deposition, sputtering and ion beam sputtering. Vapor deposition, sputtering and ion beam sputtering are preferably used because these methods may provide uniform and accurate film thickness control in a wide area. Exemplary materials of the protective layer 52 include SiO₂ and Al₂O₃ or the like. A thickness of the protective layer 52 is about 5 nm to 50 nm. By providing the protective layer 52, the antireflection structure 51 and, therefore, the first optical surface 11d and the first flange surface 11g may be provided with dustproofing, antifouling, abrasion resistance, electrostatic resistance, and other properties.

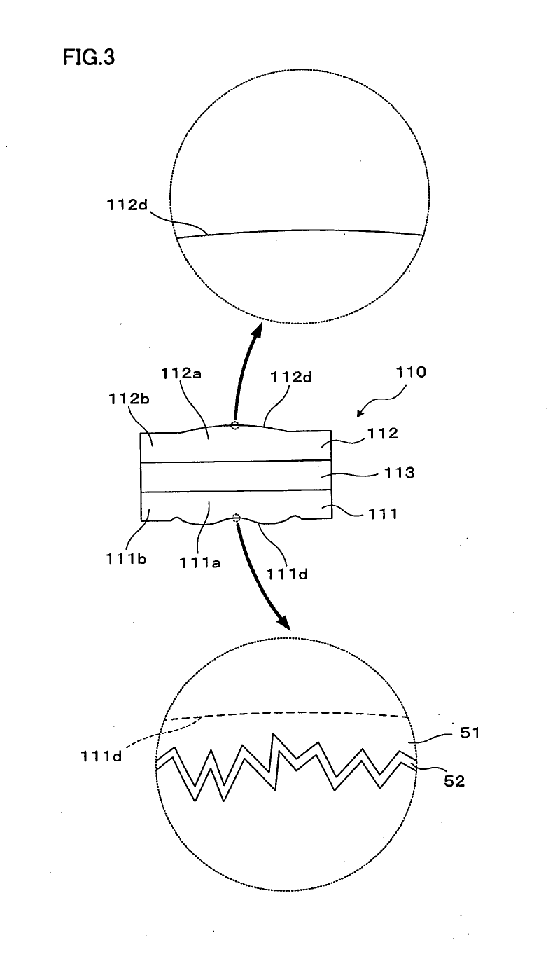

As illustrated in an enlarged view in FIG. 3, in the second compound lens 110, the antireflection structure 51 and the protective layer 52 are provided on the first optical surface 111d which is exposed to the outside of the first lens layer 111 in the same manner as the second lens layer 12 of the first compound lens 10 illustrated in FIG. 2. Since the structures of the antireflection structure 51 and the protective layer 52 are the same as those provided on the second lens layer 12, description thereof will be omitted. By providing the antireflection structure 51 on the first optical surface 111d, antireflection with reduced wavelength dependency and incidence angle dependency becomes possible. By providing the protective layer 52 on the antireflection structure 51, the first optical surface 111d and the like may be provided with dustproofing, antifouling, abrasion resistance, electrostatic resistance and other properties.

Nothing is provided on the second optical surface 112d of the second lens layer 112 and thus a base or substrate (i.e., a material of the second lens layer 112) is exposed. That is, the antireflection structure 51 and the protective layer 52 as coating layers are not provided on the second optical surface 112d; also, the antireflection film 55 illustrated in FIG. 2 is not provided.

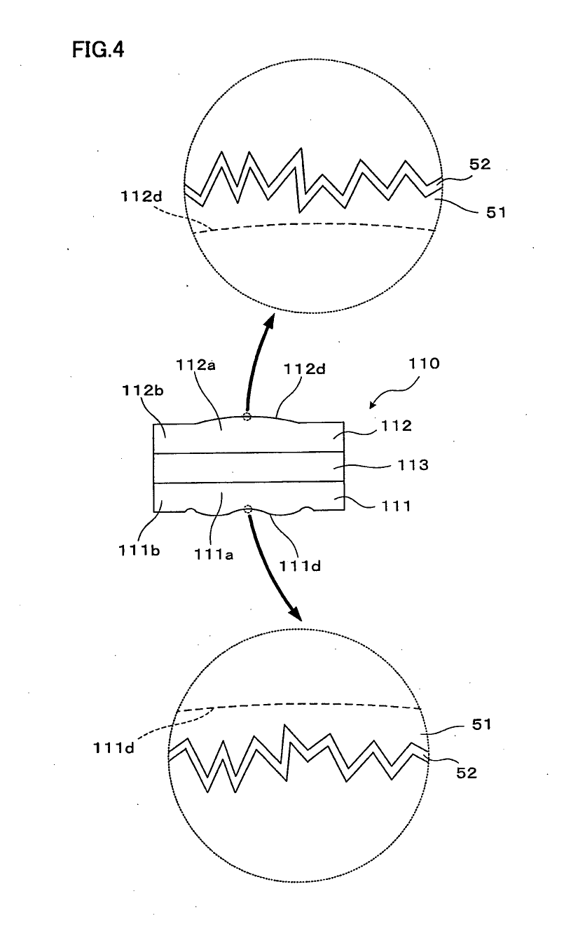

FIG. 4 is a diagram illustrating a variation of a surface structure of the second compound lens 110. In this case, the antireflection structure 51 and the protective layer 52 are provided on the first optical surface 111d of the first lens layer 111. Similarly, the antireflection structure 51 and the protective layer 52 are provided also on the second optical surface 112d of the second lens layer 112.

The combination of the coating layers described above is illustrative only and various modifications may be made. That is, the antireflection structure 51 and the protective layer 52 may be formed to cover at least one of the first optical surface 11d which is on the outer side of the first compound lens 10 and the first optical surface 111d which is on the outer side of the second compound lens 110. Further, instead of the antireflection structure 51 and the protective layer 52, the antireflection film 55 maybe formed to cover at least one of the first optical surface 11d and the first optical surface 111d which are on the outer side.

It is also possible to form the antireflection structure 51 and the protective layer 52 to cover at least one of the second optical surface 12d which is on the inner side of the first compound lens 10 and the second optical surface 112d which is on the inner side of the second compound lens 110. However, since the second optical surface 12d and the second optical surface 112d face the sealed space SP, conditions regarding durability and the like are not strict and, thus for example, the protective layer 52 may be omitted. It is not desirable to cover the second optical surfaces 12d and 112d with the multilayered antireflection film 55. The second optical surfaces 12d and 112d face the sealed space SP. Therefore, in a case in which the antireflection film 55 is formed, if a heat treatment is performed in a subsequent reflow process, the modulus of elasticity of the lens layers 12 and 112 decreases significantly on the side of the sealed space SP and, therefore, the antireflection film 55 is wrinkled due to stress of the antireflection film 55; as a result, optical performance of the compound lenses 10 and 110 deteriorates. The antireflection structure 51 may be formed not only on the optical surface but also on the flange surface. For example, in a case in which the antireflection structure 51 is formed on the second optical surface 12d of the first compound lens 10, the antireflection structure 51 may be formed not only on the second optical surface 12d but also on the second flange surface 12g. In this case, since it is not necessary to cover the second flange surface 12g with a mask or the like at the time of forming the antireflection structure 51 on the second optical surface 12d, the manufacturing procedure can be simplified. In a case in which the antireflection structure 51 is provided on the second flange surface 12g, an adhesive may be made to enter the asperity structure of the antireflection structure 51 to increase an adhesion surface area; therefore, it is possible to further increase adhesive strength between the second flange surface 12g of the first compound lens 10 and the second flange surface 112g of the second compound lens 110.

### C) Manufacturing Method of Lens Unit

A manufacturing method of a lens unit includes a process to form a pair of optical element arrays, a process to laminate and join the pair of optical element arrays, and a process to cut and divide the laminated optical element arrays into single pieces.

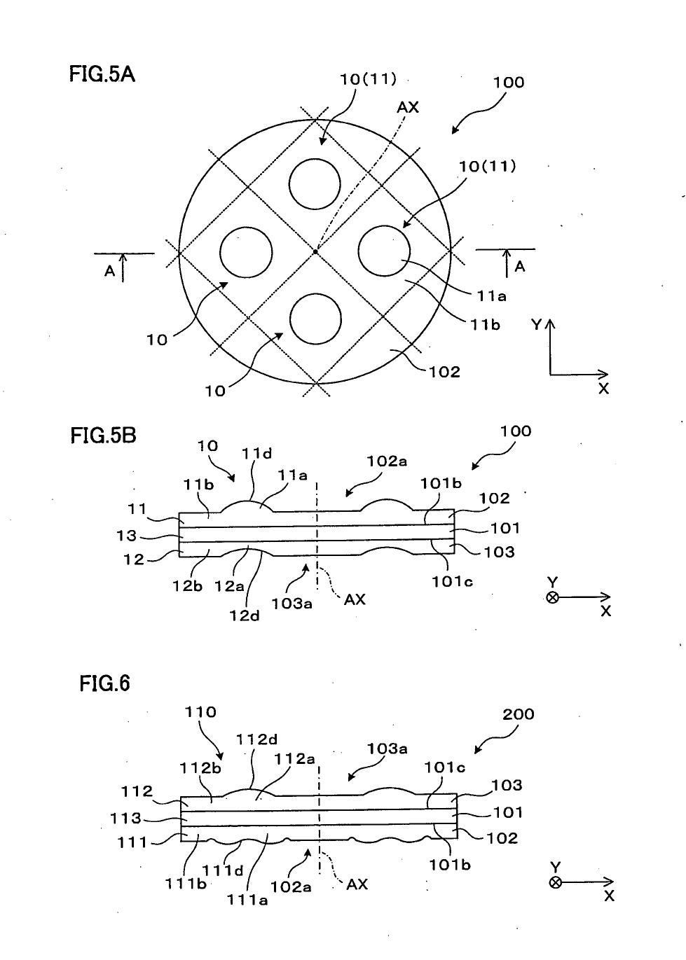

As illustrated in FIGS. 5A and 5B, a first optical element array 100 based on which the first compound lens 10 is to be formed is disc-shaped and includes a substrate 101, a first lens array layer 102 and a second lens array layer 103. The optical element array 100 has a structure in which the compound lenses 10 illustrated in FIG. 1 and other figures are arranged in a matrix form and integrated. For the convenience of description, only four compound lenses 10 are illustrated; however, actual optical element array 100 includes a great number of compound lenses 10. By laminating the optical element arrays 100 and then dividing into single pieces, post processes, such as an axial alignment of the compound lens 10, can be shortened. Here, the first lens array layer 102 and the second lens array layer 103 are aligned with each other regarding translation within an XY surface which is vertical to an axis AX and rotation about the axis AX and are joined to the substrate 101.

As illustrated in FIG. 6, a second optical element array 200 based on which the second compound lens 110 is to be formed has the same structure as that of the first optical element array 100 of FIG. 5B. The second optical element array 200 includes a substrate 101, a first lens array layer 102 and a second lens array layer 103.

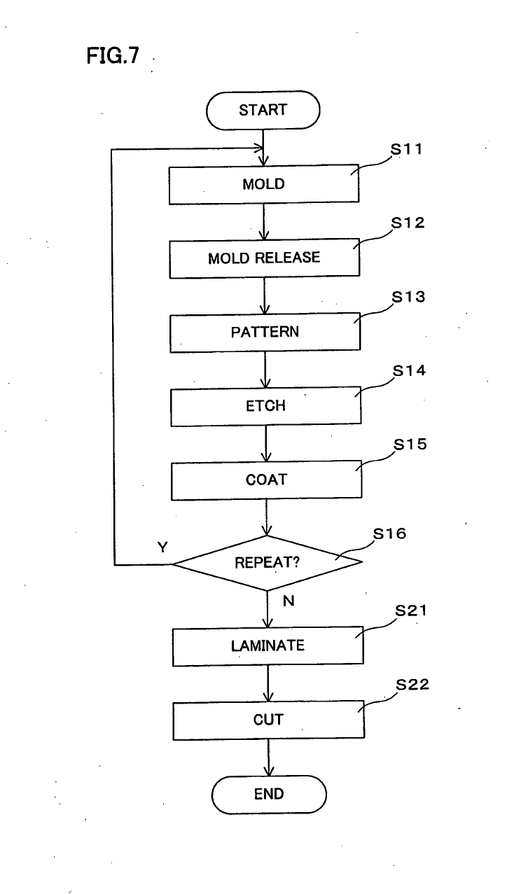

Hereinafter, a manufacturing process of the first optical element array 100 illustrated in FIG. 5B and other figures will be described with reference to FIG. 7. The manufacturing process of the first optical element array 100 basically consists of a molding process in which resin is applied to the substrate 101 and is then molded. In a case in which the antireflection structure 51 or the like is formed on a surface of the first optical element array 100, the following processes are added: a patterning process to form a mask pattern on the molded optical element array 100 before completion; an etching process to form the antireflection structures 51 on the first optical surface 11d and the second optical surface 12d of the optical element array 100; and a coating process to form the protective layers 52 on the antireflection structures 51. If the antireflection film 55 is formed on the surface of the first optical element array 100, a composite coating process to alternately laminate the high-refraction materials and the low-refraction materials is added.

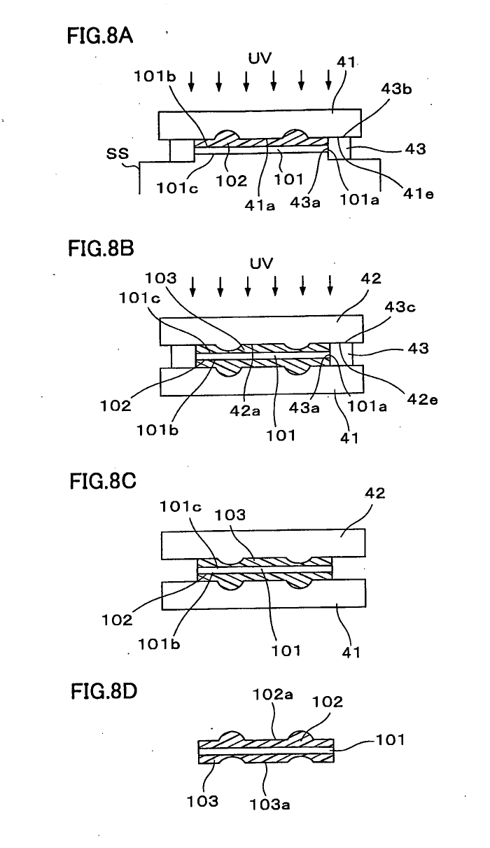

In the molding process, first, the first lens array layer 102 is molded on one surface 101b of the substrate 101 (the first half of step S11 of FIG. 7). Specifically, as illustrated in FIG. 8A, the substrate 101 is previously fixed to a stage SS using spacers 43 which hold side surfaces 101a. In this state, a resin coating apparatus (not illustrated) is operated so that resin is applied onto the surface 101b which is an upper surface of the substrate 101 fixed to the stage SS; then a first molding die 41 is lowered toward the substrate 101 onto which the resin has been applied. In a state in which an upper end surface 43b which is perpendicular to a support surface 43a of the spacer 43 is in contact with an outer edge portion 41e of the first molding die 41, a resin thickness between the substrate 101 and the first molding die 41, i.e., a thickness of the first flange layer 11b of the first lens array layer 102 is defined. Then, an UV light generator (not illustrated) is operated to emit UV light from above the first molding die 41 so as to solidify the resin disposed between one surface 101b of the substrate 101 and a transfer surface 41a of the first molding die 41, whereby the first lens array layer 102 is completed. At this time, a first molding surface 102a to which the first molding die 41 has been transferred is formed in the first lens array layer 102 (see FIG. 5B).

Next, a second lens array layer 103 is molded on the other surface 101c of the substrate 101 (the second half of step S11). Specifically, as illustrated in FIG. 8B, the substrate 101 and the first molding die 41 are inverted in an integrated manner via the first lens array layer 102 and are fixed with the other surface 101c of the substrate 101 facing upward. In this state, the resin coating apparatus (not illustrated) is operated so that resin is applied onto the surface 101c which is an upper surface of the substrate 101; then a second molding die 42 is lowered toward the substrate 101 onto which the resin has been applied. In a state in which an upper end surface 43c of the spacer 43 is in contact with an outer edge portion 42e of the second molding die 42, a resin thickness between the substrate 101 and the second molding die 42, i.e., a thickness of the second flange layer 12b of the second lens array layer 103 is defined. Then, the UV light generator (not illustrated) is operated to emit UV light from above the second molding die 42 so as to solidify the resin disposed between the other surface 101c of the substrate 101 and a transfer surface 42a of the second molding die 42, whereby the second lens array layer 103 is completed. At this time, a second molding surface 103a to which the second molding die 42 has been transferred is formed in the second lens array layer 103 (see FIG. 5B).

After the resin which forms the first lens array layer 102 and the second lens array layer 103 are solidified, as illustrated in FIG. 8C, the spacers 43 disposed between the first molding die 41 and the second molding die 42 to sandwich the substrate 101 laterally are removed. Finally, as illustrated in FIG. 8D, the first and second molding dies 41 and 42 are separated and, thereby, mold release of the first optical element array 100 from the first and second molding dies 41 and 42 is performed (step S12).

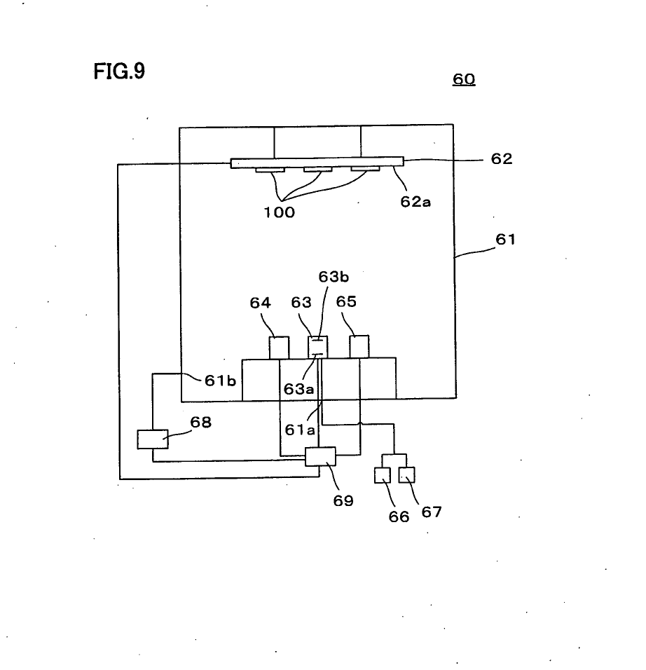

A processing apparatus 60 illustrated in FIG. 9 is an apparatus for forming an antireflection layer on the molding surfaces 102a and 103a of the first optical element array 100 illustrated in FIG. 8D. Although the processing apparatus 60 is especially for forming the antireflection structure 51 and the protective layer 52 on the molding surface 103a of the first optical element array 100, the processing apparatus 60 may also be used to form the antireflection film 55 on the molding surface 102a of the first optical element array 100. The process to form the antireflection structure 51 and the protective layer 52 includes the patterning process, the etching process and the coating process, as described above.

The processing apparatus 60 includes a vacuum chamber 61, a stage 62, an ion gun 63, a neutralizing gun 64, a vapor deposition apparatus 65, gas supply units 66 and 67, a gas discharge unit 68 and a control unit 69.

Inside the vacuum chamber 61, the stage 62, the ion gun 63, the neutralizing gun 64 and the vapor deposition apparatus 65 are provided. The vacuum chamber 61 communicates with the gas supply units 66 and 67 via a port 61a and communicates with the gas discharge unit 68 via a port 61b.

The stage 62 is provided at an upper portion in the vacuum chamber 61 and is movable in three dimensions. The first optical element array 100 is placed on and fixed to a stage surface 62a of the stage 62 which faces the ion gun 63 and the like. When a position of the stage 62 is adjusted, a position of the optical element array 100 with respect to the ion gun 63 and the like is adjusted.

The ion gun 63 is for forming the antireflection structure 51 on the first and second optical surfaces 11d and 12d of the optical element array 100. The ion gun 63 ionizes supplied gas and, at the same time, applies a beam voltage between an anode 63a and a cathode 63b of the ion gun 63. The ion gun 63 makes the ionized gas (for example, positive ion) pass through on the cathode 63b side in an accelerated manner and then emits the ionized gas toward inside the vacuum chamber 61 as an ion beam. The emitted ion beam illuminates the first and second optical surfaces 11d and 12d of the optical element array 100 on the stage 62. In this manner, exposed resin portions with no mask pattern MA, which will be described later, formed thereon of the first and second optical surfaces 11d and 12d are etched.

The neutralizing gun 64 is for neutralizing the ions in the ion beam and reducing the influence of electrolysis distribution. When the neutralizing gun 64 emits electrons, which are generated by ionization, into the vacuum chamber 61, gas ionized by the ion gun 63 is neutralized by the electrons.

The vapor deposition apparatus 65 is for forming the mask pattern MA, which will be described later, on the optical element array 100 in the patterning process and forming the protective layer 52 in the s coating process. The vapor deposition apparatus 65 performs vacuum vapor deposition of, for example, SiO₂, Al₂O₃, MgF₂, ZrO₂, TiO₂, Ta₂O₅ and CeO₂. Therefore, an island-shaped pattern which becomes the mask pattern MA and film which becomes the protective layer 52 may be formed on the first and second optical surfaces 11d and 12d of the first optical element array 100. The antireflection film 55 may also be formed on the first optical surface 11d of the optical element array 100. If a sputtering apparatus and an ion beam sputtering apparatus are provided instead of the vapor deposition apparatus 65, sputtering, ion beam sputtering or the like may also be performed.

The gas supply units 66 and 67 are for supplying introductory gas with which the ion beam is emitted. Inactive gas and reactive gas are used as the introductory gas. Exemplary inactive gas includes argon (Ar), nitrogen (N₂), helium (He), krypton (Kr), neon (Ne) and mixtures thereof. Exemplary reactive gas is oxygen (O₂). The gas discharge unit 68 is for adjusting the degree of vacuum inside the vacuum chamber 61. By using the gas discharge unit 68, gas inside the vacuum chamber 61 is evacuated to a predetermined degree of vacuum.

The control unit 69 is for controlling operations of the stage 62, the ion gun 63, the neutralizing gun 64, the vapor deposition apparatus 65 and the gas discharge unit 68.

Instead of the ion gun 63, a plasma etching apparatus may also be used. However, etching by using the ion gun 63 is preferable from the viewpoint of rapid and uniform etching in a wide area.

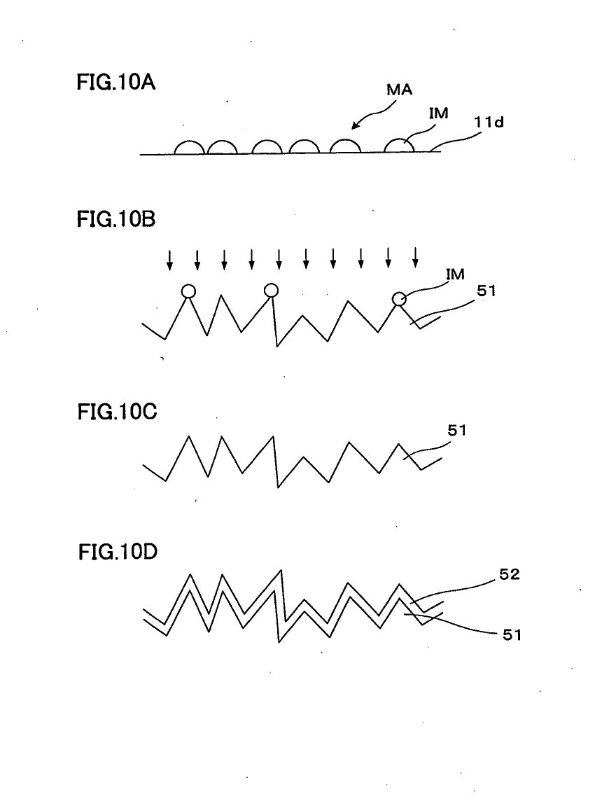

Hereinafter, with reference to FIG. 10A, the patterning process of the first optical element array 100 will be described. The patterning process is performed as a pretreatment at the time of emitting the ion beam toward the second optical surface 12d of the first optical element array 100 to form the antireflection structure 51. In the patterning process, the mask pattern MA is formed on the second optical surface 12d (step S13). The mask pattern MA is a fine island-shaped pattern as illustrated in an enlarged view in FIG. 10A. The mask pattern MA includes a plurality of randomly arranged islands IM. The patterning process is performed by using film deposition, photoresist application, etching, or the like. For example, if film deposition is used, an initial stage or process of thin film growth is employed. In the initial process of thin film growth, a state in which growth nuclei of the film become islands IM and grow, i.e., island growth, occurs. In a state of island growth before the film becomes a layer, since there are portions in which the islands IM exist and portions in which the second optical surface 12d is exposed, the film functions as a mask pattern. If the mask pattern is formed by film deposition, necessary island-shaped film may be formed by using the vapor deposition apparatus 65 of the processing apparatus 60 of FIG. 9.

In the etching process, the optical element array 100 is placed on the stage 62 of the processing apparatus 60 of FIG. 9 and the ion beam emitted from the ion gun 63 is made to illuminate a target surface of the optical element array 100, i.e., the second optical surface 12d. Then gas inside the vacuum chamber 61 is evacuated by the gas discharge unit 68. Next, introductory gas is introduced in the vacuum chamber 61. As an exemplary introductory gas, either Ar, O₂, N₂, He, Kr, Ne or a mixture thereof is used. Here, if inactive gas and reactive gas are used as the introductory gas, an etching rate can be adjusted easily. The pressure of the introductory gas is, for example, not higher than 1 Pa. Preferably, the pressure of the introductory gas is, for example, not higher than 1×10⁻² Pa. By performing etching with lower gas pressure, the mean free path of the ions becomes long. Therefore, kinetic energy of ions is not easily lost until the ions collide with the second optical surface 12d, and thus the etching rate increases. The ion beam is emitted with the vacuum chamber 61 being in the above-described state and ion irradiation is performed toward the second optical surface 12d. At this time, accelerating energy of the ions is 1 W to 100 kW. As illustrated in FIG. 10B, by the ion beam irradiation, the portions in which resin of the optical element array 100 is exposed are etched together with the islands IM of the mask pattern MA. Therefore, the antireflection structure 51 having a structure of which volume density of the asperity shapes increase toward the side of the optical element center or inside from the side of the incident light is formed (step S14). If the islands IM of the mask pattern MA are not eliminated completely after the etching process, a removal treatment of the mask pattern MA may be performed by adjusting the ion beam as illustrated in FIG. 10C.

In the coating process, the optical element array 100 is still placed on the stage 62 of the processing apparatus 60 of FIG. 9 and a vapor deposition substance from the vapor deposition apparatus 65 is made to deposit on the target surface of the optical element array 100, i.e., on the second optical surface 12d. Therefore, as illustrated in FIG. 10D, the protective layer 52 can be coated on the antireflection structure 51 (step S15). As a coating method, sputtering, ion beam sputtering, application or the like are used in place of vapor deposition described above. Vapor deposition, sputtering, ion beam sputtering or the like are preferable because these method may provide uniform and accurate film thickness control in a wide area.

If the antireflection film 55 is to be formed on the first optical surface 11d of the first optical element array 100 continuously, the first optical element array 100 on the stage 62 of the processing apparatus 60 illustrated in FIG. 9 is inverted. That is, the optical element array 100 is placed on the stage 62 and the vapor deposition substance from the vapor deposition apparatus 65 is made to deposit on the target surface of the optical element array 100, i.e., on the first optical surface 11d. By depositing the high-refraction materials and the low-refraction materials alternately, the antireflection film 55 is formed on the first optical surface 11d.

Although only the manufacture of the first optical element array 100 has been described above, the second optical element array 200 is also manufactured by repeating the same processes as those of the manufacture of the first optical element array 100 (Y of step S16 and steps S11 to S15).

The first optical element array 100 and the second optical element array 200 having the antireflection structure 51, the protective layer 52 and the like formed on their surfaces are aligned and laminated, and then bonded to each other (step S21). At this time, a UV-curing adhesive is used; then, curing by UV irradiation and finishing by heating are performed. Next, the laminated optical element arrays 100 and 200 are cut (step S22). This cutting process is performed using, for example, a laser or a rotating saw. In the processes described above, the lens unit 300 divided as a single piece from the layered product of the optical element arrays 100 and 200 may be obtained.

### D) Camera Module

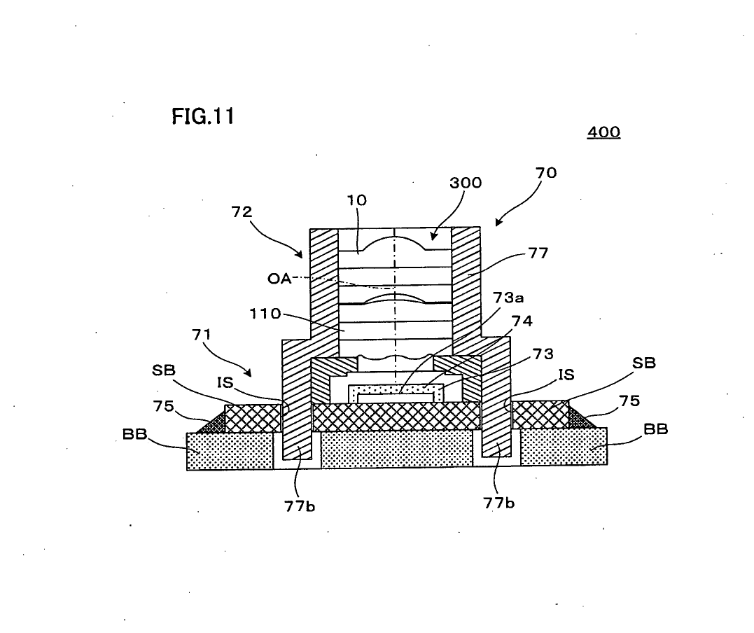

Hereinafter, a camera module 70 to which the lens unit 300 is attached will be described with reference to FIG. 11.

The camera module 70 is a small-sized camera portion (optical device) in which an image sensor which is an imaging element and an imaging lens which is a lens unit are combined. The camera module 70 may take in an image of objects. As illustrated in FIG. 11, the camera module 70 includes a body module 71 and a lens module 72. In an imaging device 400, the camera module 70 is incorporated on a circuit board BB on which electronic components which constitute electronic circuits of mobile information terminal equipment, such as a cellular phone, are mounted. Specifically, the entire camera module 70 is mounted on the circuit board BB by mounting the body module 71 on the circuit board BB.

The body module 71 is a photodetector module in which an image sensor 73 which is an imaging element, such as a charge coupled device (CCD) and a complementary metal-oxide semiconductor (CMOS), is previously mounted on a sub-substrate SB. An upper portion of the image sensor 73 is sealed by a sealing member 74. A photodetector 73a in which many pixels which perform photoelectric conversion are arranged in a grid pattern is formed on an upper surface of the image sensor 73. By forming an optical image at this photodetector 73a by the lens module 72, an image signal obtained by photoelectric conversion in each pixel is output. The sub-substrate SB is mounted on the circuit board BB with a lead-free solder 75. Therefore, the camera module 70 including the sub-substrate SB is fixed to the circuit board BB. At this time, a connecting electrode (not illustrated) of the sub-substrate SB and a circuit electrode (not illustrated) on an upper surface of the circuit board BB are electrically connected.

The lens module 72 includes an outer frame 77 which is a cylindrical holder which supports the lens unit 300 as an image pickup lens and which also functions as a sealing member. The lens unit 300 is retained in the upper portion of the outer frame 77. A lower portion of the outer frame 77 is formed as a mounting portion 77b which is inserted in a mounting hole IS provided in the sub-substrate SB so as to fix the lens module 72 to the sub-substrate SB. The fixing method includes, for example, press-fitting the mounting portion 77b in the mounting hole IS and fixing, and bonding with an adhesive.

The lens unit 300 consists of the first and second compound lenses 10 and 110 as described above (see FIG. 1) and forms an image of reflected light from a photographic subject on the photodetector 73a of the image sensor 73. An infrared (IR) cut off filter layer (not illustrated) is embedded in the lens unit 300 so as to cover a surface of a flat plate portion 13.

A manufacturing process and the like of the camera module 70 illustrated in FIG. 11 will be described. The lens unit 300 is fixed to the outer frame 77, and the outer frame 77 is connected to the sub-substrate SB using the mounting portion 77b. The image sensor 73 is attached to the sub-substrate SB; thus a state may be created in which the lens unit 300 is made to form an image on the photodetector 73a of the image sensor 73. That is, the camera module 70 is completed. Then, the camera module 70 and other electronic components are placed at predetermined mounting positions of the circuit board BB at which the solder 75 has been applied (potted) previously. Then, the circuit board BB on which the camera module 70 and other electronic components are placed is transported to a reflow furnace (not illustrated) on a conveyor belt or the like. In the reflow furnace, a reflow treatment in which the circuit board BB is heated at about 260° C. is performed to the circuit board BB. Then, the solder 75 melts and the camera module 70 is mounted on the circuit board BB together with other electronic components and the imaging device 400 is formed. The lens unit 300 is exposed to a high temperature of about 220 to 260° C. at the time of the reflow treatment. However, since the second optical surfaces 12d and 112d which face the space SP on the inner side of the lens unit 300 are covered with the antireflection structures 51 and the protective layers 52, or since the underlying bases are exposed, there is no problem that, for example, wrinkles are produced as on the antireflection film 55.

### EXAMPLE

Hereinafter, a specific Example of the lens unit 300 and a Comparative Example as a reference will be described for the comparison.

FIG. 12A is an external view illustrating a state of the second optical surfaces 12d and 112d formed on the inner side of the compound lenses 10 and 110 which constitute the lens unit 300 of the Example. FIG. 12B is an external view illustrating a state of an optical surface formed in a sealed space of a lens unit of Comparative Example. As is obvious from the drawings, it is understood that the optical surfaces 12d and 112d are relatively smooth in a case of Example illustrated in FIG. 12A while asperity wrinkles have been produced on the optical surface in the Comparative Example illustrated in FIG. 12B.

Hereinafter, experimental conditions under which samples for examination illustrated in FIGS. 12A and 12B are obtained will be described. First, a sample of Example in which the antireflection structure 51 has been formed on the optical surface which faces the sealed space, and a sample of Comparative Example in which the antireflection film 55 has been formed on the optical surface which faces the sealed space are prepared.

As the base of the antireflection structure 51, a concave surface of a double-sided lens molded from thermosetting resin is used. An ultra-thin film (about 3 nm) of TiO₂ is formed on the base. The formed ultra-thin film of TiO₂ is then subject to an ion beam etching treatment using mixed gas of Ar and O₂. Thus the antireflection structure 51 is manufactured. Regarding the antireflection film 55, the same material as that of the base of the antireflection structure 51, i.e., a concave surface of a double-sided lens, is used. A five-layer coat constituted by a low refractive index material (Substance L5) with SiO₂ being its main constituent and CeO₂ which is a high refractive index material is deposited to a height equivalent to a total of 240 nm (23 nm, 23.3 nm, 41.1 nm, 50 nm and 103.6 nm from the base side) to manufacture the antireflection film 55. Regarding the antireflection film 55, in order to apply high temperature resistance, film formation as described above is performed at high temperature of 190° C. The thus obtained antireflection structure 51 and the antireflection film 55 are joined to other lenses on the sealed side and used as a sample for an examination.

The details of the examination about the thermal endurance of the sample of Example in which the antireflection structure 51 is formed and the sample of Comparative Example in which the antireflection film 55 is formed are as follows: 2 minutes and 30 seconds high temperature examinations are performed continuously three times using an infrared oven at a surface temperature of not lower than 217° C. (the temperature is set to reach the highest temperature of 260° C. in this 2 minutes and 30 seconds). After these three times of heating events, the sample is cooled to the normal temperature; then the antireflection structure 51 and the antireflection film 55 are examined using a microscope. The results are illustrated in FIGS. 12A and 12B as described above.

According to the lens unit 300 of the first embodiment described above, since at least one of the compound lenses 10 and 110 made of heat-resistant resin includes the antireflection structure 51 as a fine asperity structure layer on the surface on the inner side facing the space, even if a subsequent heat treatment is performed, a decrease in optical performance of the lens due to wrinkling can be prevented unlike a case in which the antireflection film is provided.

### Second Embodiment

Hereinafter, a camera module and the like according to a second embodiment will be described. Since the camera module and the like of the second embodiment are variations of the camera module and the like of the first embodiment, portions not especially described are to be considered as the same as those of the first embodiment.

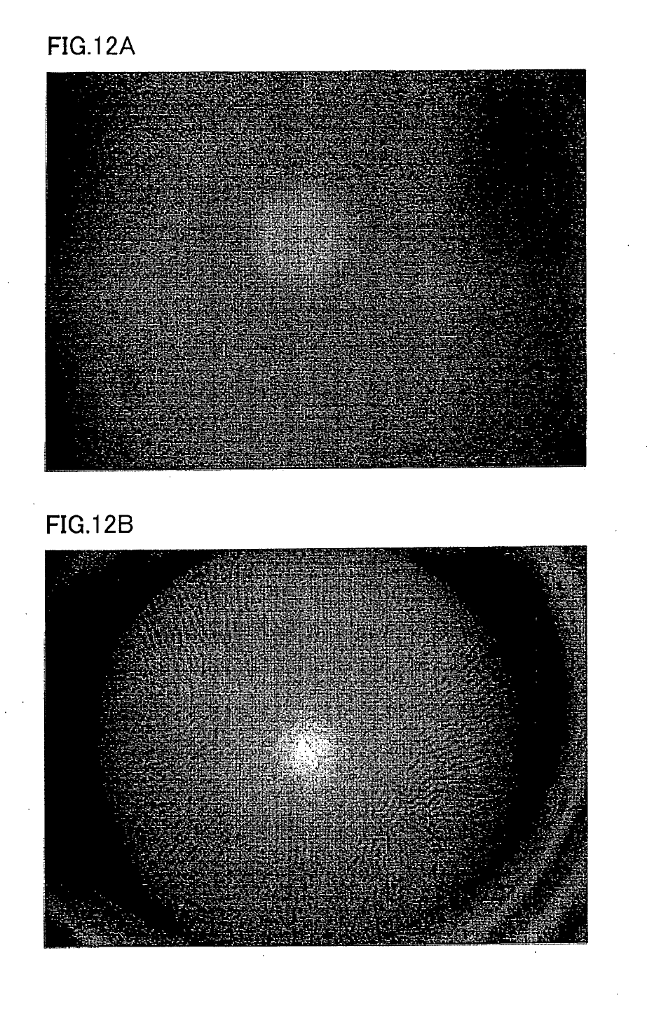

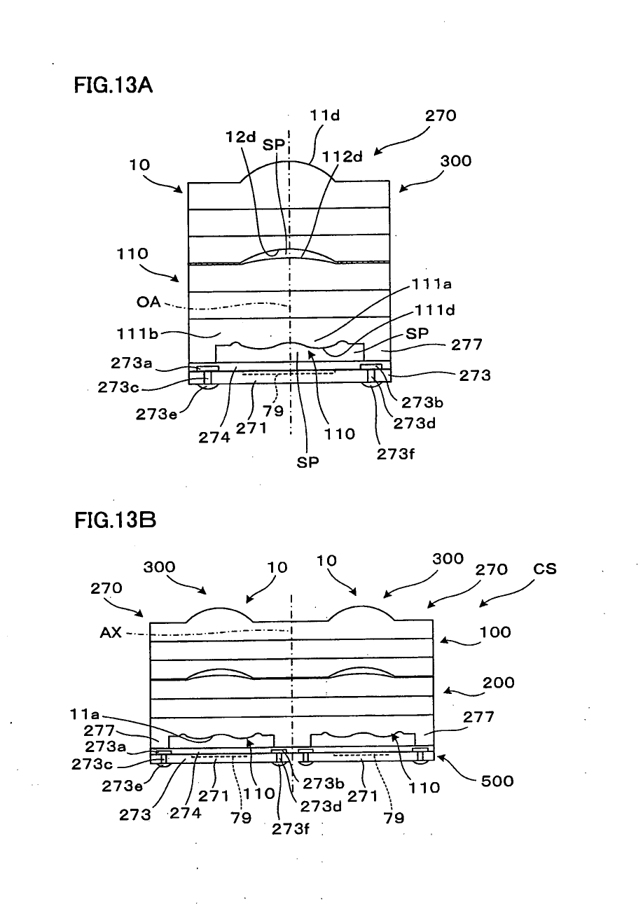

As illustrated in FIG. 13A, a camera module 270 includes an image sensor chip 271 and a lens unit 300. The camera module 270 itself is an optical device but includes, as a part thereof, the lens unit 300 which is an optical device. The camera module 270 is incorporated in an imaging device 400 through a reflow process in the same manner as in the camera module 70 of FIG. 11.

Although the lens unit 300 has substantially the same structure as that illustrated in FIG. 1, a second compound lens 110 includes a lens support 277 which extends from a first flange layer 111b. The lens support 277 is a rectangular frame shaped member which functions as a spacer or a sealing member, and projects along an optical axis OA further toward the image sensor chip 271 than a first body layer 111a of the second compound lens 110.

In the lens unit 300, an antireflection structure 51 and a protective layer 52 may be formed to cover a first optical surface lid which is on the outer side. Further, instead of the antireflection structure 51 and the protective layer 52, an antireflection film 55 may be formed to cover the first optical surface 11d which is on the outer side. The antireflection structure 51 and the protective layer 52 may be formed to cover a first optical surface 111d on the inner side which faces a space SP on the side of a sensor and to cover second optical surfaces 12d and 112d which face a space SP between the lenses, but the antireflection film 55 is not formed.

The image sensor chip 271 includes a silicon chip 273 and a support glass substrate 274. A sensor body 79, such as a CCD and a CMOS, is formed on a surface of the silicon chip 273 on the outer side. Electrode pads 273a and 273b are formed in the periphery of the surface of the silicon chip 273. These electrode pads 273a and 273b are connected to an input/output circuit of the image sensor chip 271. On a lower surface of the electrode pads 273a and 273b, re-wiring portions 273c and 273d which penetrate the silicon chip 273 and reach a rear surface of the image sensor chip 271 are connected. The re-wiring portions 273c and 273d are exposed to the periphery of a rear surface of the silicon chip 273. Bump electrodes 273e and 273f are formed on the re-wiring portions 273c and 273d of the rear surface of the silicon chip 273. The support glass substrate 274 on the inner side is for supporting the silicon chip 273 and is provided to cover the CCD, CMOS or the like.

Hereinafter, a manufacturing method of the camera module 270 will be described with reference to FIG. 13B. The camera module 270 of the second embodiment is manufactured by cutting and dividing from a product in which first and second optical element arrays 100 and 200, and an imaging element array 500 on which a plurality of sensor bodies 79, such as CCD and CMOS, are formed are combined.

First, the first and second optical element arrays 100 and 200 and the imaging element array 500 are manufactured. Here, in the imaging element array 500, a plurality of image sensor chips 271 which are imaging elements are disposed corresponding to the positions of the lens units 300 of the laminated optical element arrays 100 and 200.

Next, a pair of optical element arrays 100 and 200 and the imaging element array 500 are laminated to manufacture a structure CS. Components which constitute this structure CS are mutually fixed by an adhesive.

Next, the structure CS in which the pair of optical element arrays 100 and 200 and the imaging element array 500 are bonded is cut by using a laser, a rotating saw or the like along a boundary of two adjoining image sensor chips 271. Thereby, the camera module 270 which has been divided into a single piece is manufactured.

Then, the camera module 270 is mounted on a target circuit board (not illustrated) via the bump electrodes 273e and 273f on the rear surface of the image sensor chip (imaging element) 271. Specifically, the camera module 70 and other electronic components are placed at predetermined mounting positions of the circuit board at which solder has been applied (potted) previously. Thus, the circuit board on which the camera module 270 and other electronic components are placed is transported to a reflow furnace (not illustrated) on a conveyor belt or the like, where the circuit board is subject to a reflow treatment to be heated at a temperature of about 220 to 260° C. Then, the solder melts and the camera module 270 is mounted on the circuit board together with other electronic components and the imaging device is formed.

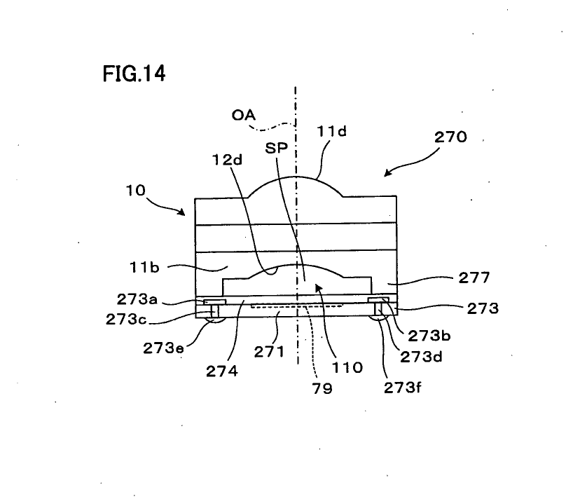

FIG. 14 illustrates a variation of the camera module 270 illustrated in FIG. 13A. In this case, the camera module 270 is not a lens unit but an imaging device (optical device) formed by joining the first compound lens 10 and the image sensor chip 271. In the camera module 270 illustrated in FIG. 14, the first compound lens 10 corresponds to a lens and the image sensor chip 271 corresponds to an optical member.

In the camera module 270, a lens support 277 which functions as a sealing member is provided in the first compound lens 10 in order to adjust a distance between the first compound lens 10 and the image sensor chip 271. A sealed space SP is formed between the first compound lens 10 and the image sensor chip 271. In this case, the first compound lens 10 is an image pickup lens which constitutes the optical device or the imaging device, and the image sensor chip 271 is an imaging element which detects a light beam which has passed the first compound lens 10.

In the camera module 270 of this variation, an antireflection structure 51 and a protective layer 52 may be formed to cover a first optical surface 11d which is on the outer side of the first compound lens 10. Further, instead of the antireflection structure 51 and the protective layer 52, an antireflection film 55 may be formed to cover the first optical surface lid which is on the outer side.

In this camera module 270, a second optical surface 12d which is on the inner side of the first compound lens 10 faces a space SP, and the antireflection structure 51 and the protective layer 52 may be formed to cover the second optical surface 12d. It is not desirable to cover the second optical surface 12d with the multilayered antireflection film 55.

### Third Embodiment

Hereinafter, a lens unit (optical device) according to a third embodiment will be described. Since the lens unit of the third embodiment is a variation of the lens unit of the first embodiment, portions not especially described are to be considered as the same as those of the first embodiment.

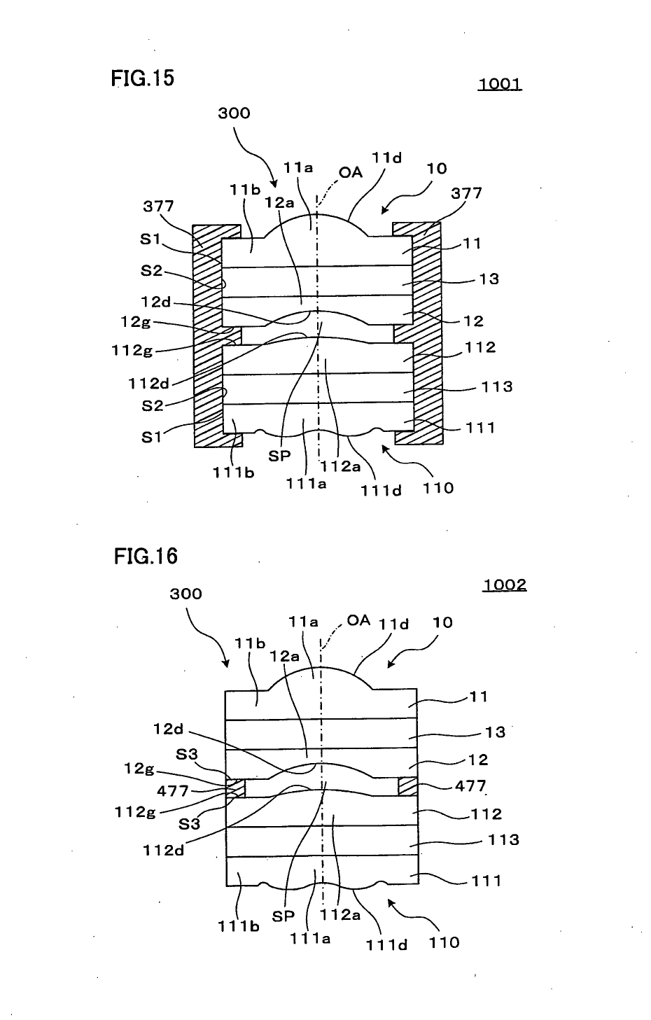

As illustrated in FIG. 15, a lens unit 1001 (optical device) of the third embodiment includes a first compound lens 10, a second compound lens 110 and a lens barrel 377. The first compound lens 10 and the second compound lens 110 are bonded in a fitted manner to the lens barrel 377 which is a sealing member, and are fixed in a mutually aligned state via the lens barrel (sealing member) 377. At this time, a space between side surfaces S1 of the first and second compound lenses 10 and 110 and the like and an inner surface S2 of the lens barrel 377 and the like is filled with an adhesive to avoid air leak. Thus, a sealed space SP is formed between the first compound lens 10 and the second compound lens 110.

Here, an antireflection structure 51 and a protective layer 52 may be formed to cover at least one of a first optical surface 11d which is on the outer side of the first compound lens 10 and a first optical surface 111d which is on the outer side of the second compound lens 110. Further, instead of the antireflection structure 51 and the protective layer 52, an antireflection film 55 may be formed to cover at least one of the first optical surface 11d and the first optical surface 111d which are on the outer side.

It is also possible to form the antireflection structure 51 and the protective layer 52 to cover at least one of a second optical surface 12d which is on the inner side of the first compound lens 10 and a second optical surface 112d which is on the inner side of the second compound lens 110. It is not desirable to cover the second optical surfaces 12d and 112d with the multilayered antireflection film 55.

### Fourth Embodiment

Hereinafter, a lens unit (optical device) according to a fourth embodiment will be described. Since the lens unit of the fourth embodiment is a variation of the lens unit of the first embodiment, portions not especially described are to be considered as the same as those of the first embodiment.

As illustrated in FIG. 16, a lens unit 1002 (optical device) of the fourth embodiment includes a first compound lens 10, a second compound lens 110 and a spacer 477. The first compound lens 10 and the second compound lens 110 are bonded to the spacer 477 so as to dispose the spacer 477 which is a sealing member therebetween and are fixed in a mutually aligned manner regarding the distance and the like via the spacer (sealing member) 477. At this time, a space between second flange surfaces 12g and 112g of the first and second compound lenses 10 and 110 and a support surface S3 of the spacer 477 is filled with an adhesive to avoid air leak. Thus, a sealed space SP is formed between the first compound lens 10 and the second compound lens 110.

Here, an antireflection structure 51 and a protective layer 52 may be formed to cover at least one of a first optical surface 11d which is on the outer side of the first compound lens 10 and a first optical surface 111d which is on the outer side of the second compound lens 110. Further, instead of the antireflection structure 51 and the protective layer 52, an antireflection film 55 may be formed to cover at least one of the first optical surface 11d and the first optical surface 111d which are on the outer side.

It is also possible to form the antireflection structure 51 and the protective layer 52 to cover at least one of a second optical surface 12d which is on the inner side of the first compound lens 10 and a second optical surface 112d which is on the inner side of the second compound lens 110. It is not desirable to cover the second optical surfaces 12d and 112d with the multilayered antireflection film 55. The antireflection structure 51 may be formed on the second flange surfaces 12g and 112g. In a case in which the antireflection structure 51 is formed in the second flange surfaces 12g and 112g, an adhesive may be made to enter an asperity structure of the antireflection structure 51 to increase an adhesion surface area; therefore, it is possible to further increase adhesive strength between the second flange surface 12g of the first compound lens 10 and the support surface S3 of the spacer 477, and adhesive strength between the second flange surface 112g of the second compound lens 110 and the support surface S3 of the spacer 477.

### Fifth Embodiment

Hereinafter, an optical element array and the like according to a fifth embodiment will be described. Since the optical element array and the like of the fifth embodiment are variations of the optical element array and the like of the first embodiment, portions not especially described are to be considered as the same as those of the first embodiment.

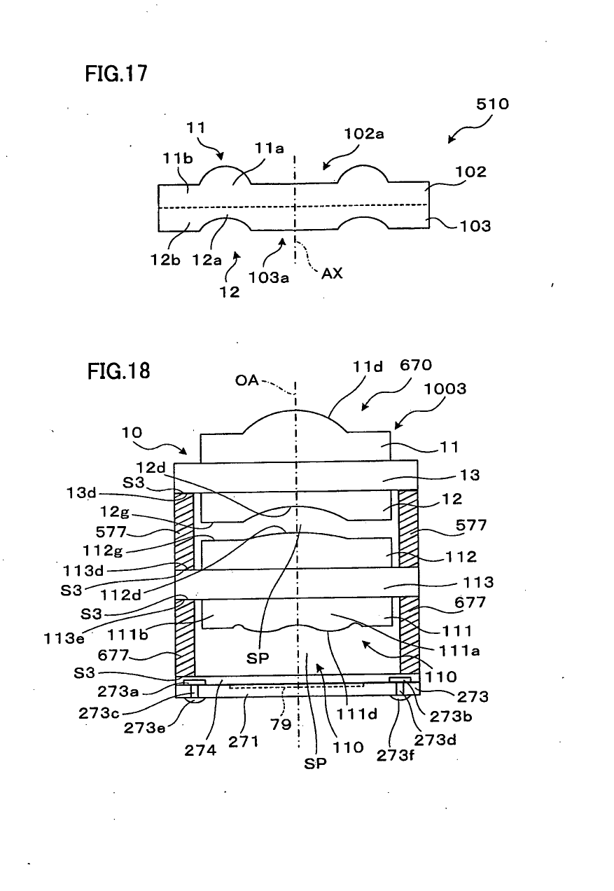

As illustrated in FIG. 17, a substrate 101 is not provided in an optical element array 510 of the fifth embodiment. That is, the optical element array 510 includes a first lens array layer 102 and a second lens array layer 103. Therefore, if the first and second lens array layers 102 and 103 to be molded are stable in shape themselves and molding thereof is easy, it is not necessary to use the substrate 101. In FIG. 17, for convenience, a boundary between the first lens array layer 102 and the second lens array layer 103 is illustrated by a dotted line; however, the first and second lens array layers 102 and 103 may be molded integrally.

### Sixth Embodiment

Hereinafter, a camera module and the like according to a sixth embodiment will be described. Since the camera module and the like of the sixth embodiment are variations of the camera module and the like of the first embodiment, portions not especially described are to be considered as the same as those of the first embodiment.

As illustrated in FIG. 18, a camera module 670 includes an image sensor chip 271 and a lens unit 1003. The camera module 670 itself is an optical device but includes, as a part thereof, the lens unit 1003 which is an optical device.

The lens unit 1003 includes a first compound lens 10, a second compound lens 110 and spacers 577 and 677. In the first and second compound lenses 10 and 110, outer diameters of flat plate portions 13 and 113 are larger than outer diameters of first and second lens layers 11, 111, 12 and 112. Portions of the flat plate portions 13 and 113 exposed from the first and second lens layers 11, 111, 12 and 112 are flat surfaces and have areas large enough to support the spacers 577 and 677. The first compound lens 10 is manufactured, for example in the first optical element array 100 illustrated in FIG. 5, not by forming first and second lens array layers 102 and 103 in a joined state but by separately forming portions corresponding to the first and second lens layers 11 and 12 of the first compound lens 10. It is also possible to separately manufacture the first compound lens without manufacturing the first optical element array 100. This is the same about the manufacture of the second compound lens 110.

The flat plate portion 13 of the first compound lens 10 and the flat plate portion 113 of the second compound lens 110 are bonded to the spacer 577 so as to dispose the spacer 577 which is a sealing member therebetween and are fixed in a mutually aligned manner regarding the distance and the like via the spacer (sealing member) 577. At this time, a space between surfaces 13d and 113d at which the flat plate portions 13 and 113 are exposed from the second lens layers 12 and 112 of the first and second compound lenses 10 and 110 and a support surface S3 of the spacer 577 is filled with an adhesive to avoid air leak. Thus, a sealed space SP is formed between the first compound lens 10 and the second compound lens 110.

The flat plate portion 113 of the second compound lens 110 and the image sensor chip 271 are bonded to the spacer 677 so as to dispose the spacer 677 which is a sealing member therebetween and are fixed in a mutually aligned manner regarding the distance and the like via the spacer (sealing member) 677. At this time, a space between a surface 113e from which the flat plate portion 113 is exposed from the first lens layer 111 of the second compound lens 110 and a support surface S3 of the spacer 677 is filled with an adhesive to avoid air leak. Further, a space between a surface of the image sensor chip 271 and the support surface S3 of the spacer 677 is also filled with an adhesive. Therefore, a sealed space SP is formed between the first compound lens 10 and the image sensor chip 271.

In the lens unit 1003, an antireflection structure 51 and a protective layer 52 may be formed to cover a first optical surface 11d which is on the outer side. Further, instead of the antireflection structure 51 and the protective layer 52, an antireflection film 55 may be formed to cover the first optical surface 11d which is on the outer side. The antireflection structure 51 and the protective layer 52 may be formed to cover a first optical surface 111d on the inner side which faces a space SP on the side of a sensor and to cover second optical surfaces 12d and 112d which face a space SP between the lenses, but the antireflection film 55 is not formed.

In the present embodiment, if the flat plate portions 13 and 113 are formed by glass, bonding surfaces of the flat plate portions 13 and 113 to be bonded to the spacers 577 and 677 become flat. Since glass is hard to be etched compared with resin, when the second optical surfaces 12d and 112d and the like are etched, the flat plate portions 13 and 113 which are made of glass are not etched. That is, no asperity structure (antireflection structure) is formed in the exposed portions of the flat plate portions 13 and 113. Therefore, the bonding surfaces between the spacers 577 and 677 and the flat plate portions 13 and 113 may be made flat. Thus, as compared with a case in which bonding is performed on a surface on which an antireflection structure is formed, production of fine powder of chipped antireflection structure may be avoided.

Although the manufacturing method of the optical element array and the like according to the present embodiment have been described above, the manufacturing method of the optical element array according to the present invention is not limited to that described above. For example, in the embodiment described above, the shape and size of the first and second optical surfaces 11d, 12d, 111d and 112d may be suitably changed depending on the use or the function.

Although the first compound lens 10 includes the first lens layer 11, the second lens layer 12 and the flat plate portion 13 in the embodiment described above, either of the first lens layer 11 or the second lens layer 12 may be omitted. Similarly, in the first compound lens 110, either of the first lens layer 111 or the second lens layer 112 may be omitted.

In the embodiment described above, the optical element arrays 100 and 200 may be formed by various methods other than using a molding die in which resin is poured and solidified. For example, the optical element array 100 may be manufactured by heat fusion, heat treatment, vapor deposition, injection molding, application, etching after deposition and the like. Considering shape accuracy and molding time of the first and the second optical surfaces 11d, 12d, 111d and 112d, methods using injection molding or using a molding die are desirable.

1. An optical device, comprising:
a lens;
an optical member which faces the lens via a space; and
a sealing member which airtightly seals the space disposed between the lens and the optical member,
wherein the lens is made of heat-resistant resin and has a fine asperity structure layer which is an antireflection layer on an inside surface facing the space, the asperity structure layer being made of substantially the same material as that of a base of the lens and the asperity structure layer and the base of the lens being formed integrally.

2. The optical device according to claim 1, wherein the heat-resistant resin is one of thermosetting resin and photocuring resin.

3. The optical device according to claim 1, wherein the sealing member is an adhesive which joins the lens and the optical member at a position out of an optical path.

4. The optical device according to claim 1, wherein the sealing member is a lens barrel which mutually aligns and retains the lens and the optical member.

5. The optical device according to claim 1, wherein the sealing member is a spacer which mutually aligns and joins the lens and the optical member.

6. The optical device according to claim 5, wherein:
the lens includes a flat plate portion;
the flat plate portion includes a resin layer which is made of the heat-resistant resin on at least an inside surface facing the space;
an outer diameter of the resin layer is smaller than an outer diameter of the flat plate portion; and
the spacer is joined to a surface of the flat plate portion at which the flat plate portion is exposed from the resin layer.

7. The optical device according to claim 1, wherein the lens includes an optical surface and a flange surface which extends from the periphery of the optical surface, and the asperity structure layer is provided on the optical surface.

8. The optical device according to claim 1, wherein the lens includes an optical surface and a flange surface which extends from the periphery of the optical surface, and the asperity structure layer is provided on the optical surface and on the flange surface.

9. The optical device according to claim 1, wherein the lens is a first lens element and the optical member is a second lens element.

10. The optical device according to claim 9, further comprising an imaging element which is disposed at either of a position of the opposite side of the second lens element adjoining the first lens element, or a position of the opposite side of the first lens element adjoining the second lens element, the imaging element being configured to detect a light beam which has passed the first and second lens elements.

11. The optical device according to claim 9, wherein the second lens element includes no fine asperity structure layer made of heat-resistant resin and no antireflection film on a surface facing the space and thus a base is exposed.

12. The optical device according to claim 9, wherein the second lens element is made of heat-resistant resin and has a fine asperity structure layer on a surface facing the space.

13. The optical device according to claim 9, wherein an antireflection film or a protective film is formed on at least one of a surface of the first lens element on the opposite side of the second lens element and a surface of the second lens element on the opposite side of the first lens element.

14. The optical device according to claim 9, wherein a fine asperity structure layer is formed on at least one of a surface of the first lens element on the opposite side of the second lens element and a surface of the second lens element on the opposite side of the first lens element.

15. The optical device according to claim 1, wherein the optical member is an imaging element configured to detect a light beam which has passed the lens.

16. The optical device according to claim 1, wherein the asperity structure layer includes an antireflection structure and a protective layer formed on a surface of the antireflection structure.

17. An imaging device comprising the optical device according to claim 1.

18. A manufacturing method of an imaging device which includes a lens and an optical member which faces the lens via a space, the method comprising:
a process to form a fine asperity structure layer which is an antireflection layer made of heat-resistant resin on an inside surface of the lens to face the space;
a process to fix the lens and the optical member while airtightly sealing the space disposed between the lens and the optical member by a sealing member; and
a process to heat-treat the fixed lens and the optical member.
